(19) United States
(12) Patent Application Publication
(10) Pub. No.: US 2013/0206127 A1
(43) Pub. Date: Aug. 15, 2013

(54) Metamorphic Stone Table-Top Grill

(71) Applicant: SizzleStone, LLC, (US)

(72) Inventor: Milton T. Bugg, JR., Gilbert, AZ (US)

(73) Assignee: SIZZLESTONE, LLC, Gilbert, AZ (US)

(21) Appl. No.: 13/631,722

(22) Filed: Sep. 28, 2012

Related U.S. Application Data
(60) Provisional application No. 61/540,447, filed on Sep. 28, 2011.

(51) Int. Cl. A47J 37/07

(52) U.S. Cl. CPC A47J 37/0781
USPC 126/8; 126/43

(57) ABSTRACT

A functionally and aesthetically improved, indoor/outdoor metamorphic stone table-top grill, including a pre-heated, metamorphic stone (preferably absolute black granite or black galaxy granite) as the cooking surface; a custom designed and engineered cone ceramic bowl; a stainless steel grate to mount, hold and support the metamorphic cooking stone, in suspension above the ceramic bowl; and one or more (preferably two) disposable cans of formulated, denatured alcohol, water and gel (for example, Sterno™ cans are suitable), which are placed in the well of the ceramic bowl and which provide continuous heat.

### RELATED APPLICATION(S)

This application claims priority of U.S. Provisional Patent Application Ser. No. 61/540,447, filed on Sep. 28, 2011, entitled “METAMORPHIC STONE TABLE-TOP GRILL,” which application is incorporated in its entirety in this application by this reference.

### BACKGROUND

Using heated stones as a surface for cooking food has long been a part of culinary preparation. One of the benefits of cooking with a heated stone is that there is no direct flame applied to the food, reducing the likelihood of scorching or scalding the food. Also, cooking with a heated stone provides a unique food preparation and eating experience, with the attendant enjoying the sounds and smells no matter what the food being prepared, such as meat, chicken, seafood, vegetables, or any other food that may be grilled. Also, each bite of food may be seasoned individually and separately, because the cooking is happening together with the dining experience. In many cases, it is a healthier way to prepare food as well, without the need for cooking oils, fats, or excessive salts. Pre-heated, metamorphic stones are particularly useful in cooking food, particularly granite.

Cooking food with pre-heated stones can be done on either a large scale or a small scale. On a small scale, an appropriately-sized, pre-heated stone can be mounted in a frame or other container and placed on the flat surface of a table-top or counter for cooking and then eating food in proximity to the table-top stone grill. This small scale food preparation provides culinary and aesthetic benefits to the dining experience, as the participants can be socializing together around the cooking stone, while at the same time preparing and eating food cooked on a table-top, stone grill. This provides a fun, dynamic, and socially pleasant environment for the family or group dining experience.

Until the present invention, cooking with a table-top, pre-heated stone has been a less-than-ideal process. Some applications require using an individual, pre-heated stone (sometimes as hot as 500 degrees) as a dining plate, which risks burning fingers or hands or worse. In some applications, the pre-heated stone is mounted on a stand which is unwieldy, unstable or which exacerbates the dissipation of heat from the stone. In some applications, there is no heat source mechanism for continually adding, and sustaining, heat to the pre-heated stone during the cooking/dining experience, which also exacerbates (unnecessarily) the dissipation of heat from the pre-heated cooking stone.

### BRIEF DESCRIPTION OF THE DRAWINGS

FIG. 1 included herein shows an example of an embodiment of a SizzleStone Metamorphic Stone [Granite] in accordance with the invention having measurement specifications of 5″×10″×¾″.

FIG. 2 included herein shows an example of an embodiment of a SizzleStone Suspension Grate in accordance with the invention having the measurement specifications noted thereon.

FIG. 3 included herein shows a perspective view of the SizzleStone Suspension Grate shown in FIG. 2.

FIG. 4 included herein shows a top view, a side view, and an end view of an example of an embodiment of a SizzleStone Cone 6 Ceramic Bowl in accordance with the invention having the measurement specifications noted thereon.

FIG. 5 included herein shows a front view and a perspective view of the SizzleStone Cone 6 Ceramic Bowl shown in FIG. 4, with air ventilation holes.

FIG. 6 included herein shows a perspective view of an example of an embodiment of a SizzleStone Metamorphic Stone [Granite] positioned on a SizzleStone Suspension Grate, two disposable cans containing a heat source, and a SizzleStone Cone 6 ceramic bowl with inserts showing two ignited heat sources positioned within the ceramic bowl.

FIG. 7 included herein shows a side view of an example of an embodiment of a SizzleStone Metamorphic Stone [Granite] positioned on an example of an embodiment of a SizzleStone Suspension Grate, and a schematic diagram of a side view of an example of an embodiment of a SizzleStone Cone 6 ceramic bowl with an ignited heat source positioned therein, arrows indicating air flow, and spirals indicating heat convection.

### DETAILED DESCRIPTION

The present invention—called the SizzleStone Table Top Grill (“SizzleStone”)—provides an aesthetically and functionally improved metamorphic stone table-top grill. The SizzleStone is an indoor/outdoor cooking vessel that uses a pre-heated, metamorphic stone (preferably absolute black granite or black galaxy granite) as the cooking surface. The metamorphic stone is preferably approximately 5″×10″×¾″ in dimension, and is highly polished on the top grilling surface and also, preferably, on all four adjacent sides. The metamorphic stone may also be customized with colors, designs, script, logos, etc. for a personalized touch. Metamorphic stone also is durable and easy to clean, even in the dishwasher.

In addition to the metamorphic cooking stone described above, the complete SizzleStone vessel also includes: (1) a custom designed and engineered cone 6 ceramic bowl; (2) a 304 stainless steel grate to mount, hold and support the metamorphic cooking stone, in suspension above the ceramic bowl; and (3) one or more (preferably two) disposable cans of formulated, denatured alcohol, water and gel (for example, Sterno™ cans are suitable), which are placed in the well of the ceramic bowl to provide continuous heat.

An important aspect of item (3) above is that the heat from the cans placed in the well of the ceramic bowl function to slow the rate of thermal discharge from the metamorphic cooking stone. This is important because after being pre-heated, the metamorphic cooking stone dissipates its absorbed heat in the ambient, room temperature air as it is used for cooking. The stone has no way to maintain its pre-heated temperature unless an external heat source is used. The alcohol/water cans in the well of the ceramic bowl provide that external heat source.

An important aspect of item (1) above, the custom designed and engineered ceramic bowl, is that its engineered design and shape functions as an ideal geometric structure to create the best possible convection heating of the metamorphic cooking stone. This engineered feature significantly reduces the rate of thermal discharge (or, said another way, increases thermal retention) of the metamorphic stone, which prolongs the amount of time the surface will remain hot enough to use for cooking.

Moreover, the ceramic bowl includes appropriately-sized ventilation holes on each end, which allow the right amount of air to convex into the bowl for the disposable cans of formulated denatured alcohol, water, and gel to burn most effectively.

An important aspect of item (2) above, the stainless steel grate, is that it functions to (a) suspend the metamorphic stone above the continuous heating source (item (3) above), and (b) prevent the metamorphic stone from slipping or falling off the bowl/grate combination (cooking vessel), which is essential obviously for safety purposes when the participants are in close proximity to a very hot metamorphic stone suspended on the stainless steel grate.

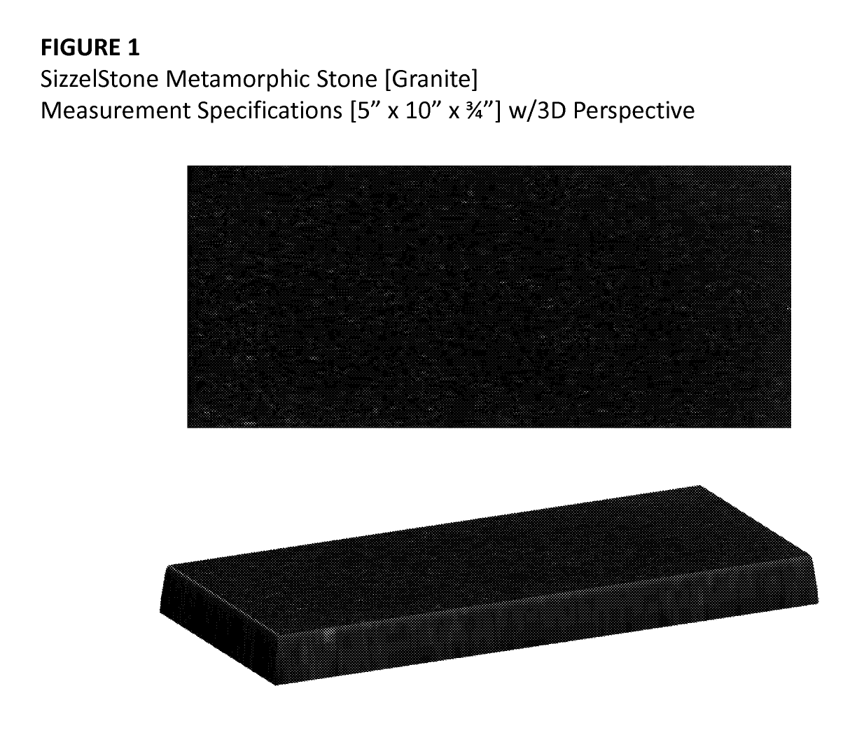

The attached illustration FIG. 1 shows a perspective view of the preferred SizzleStone metamorphic stone, which is made of granite and has measurement dimensions/specifications of 5″×10″×¾″.

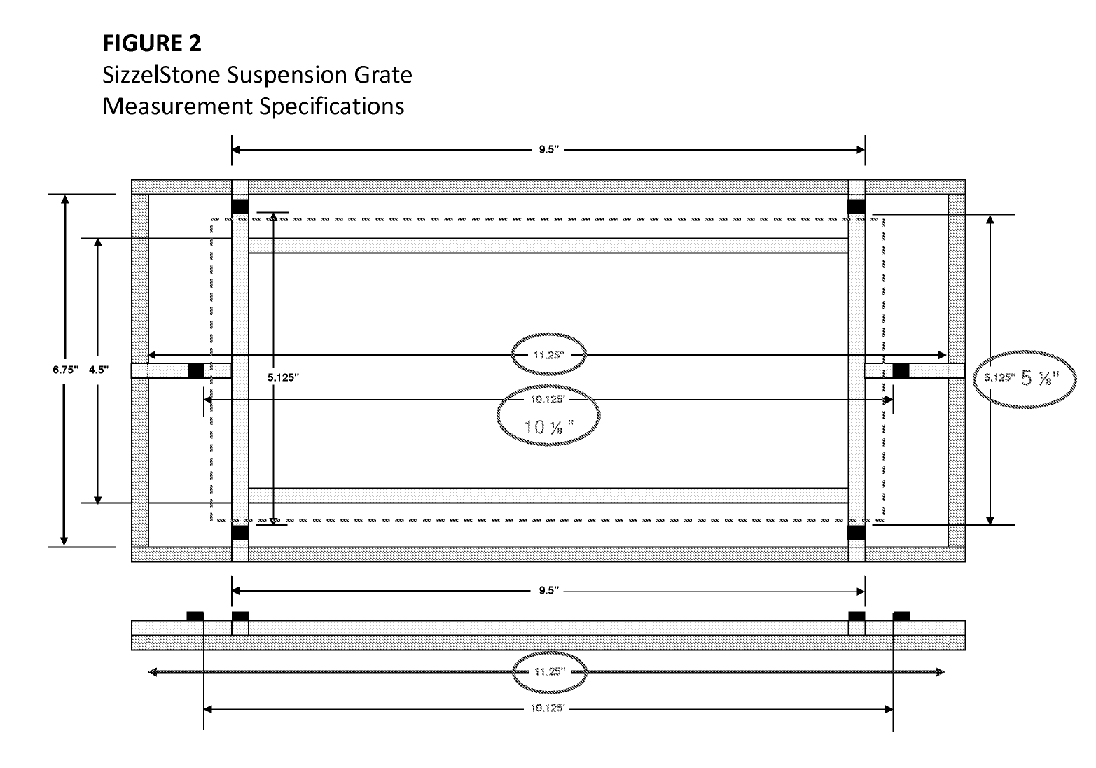

The attached illustration FIG. 2 shows the preferred SizzleStone metamorphic stone suspension grate, with preferred specifications.

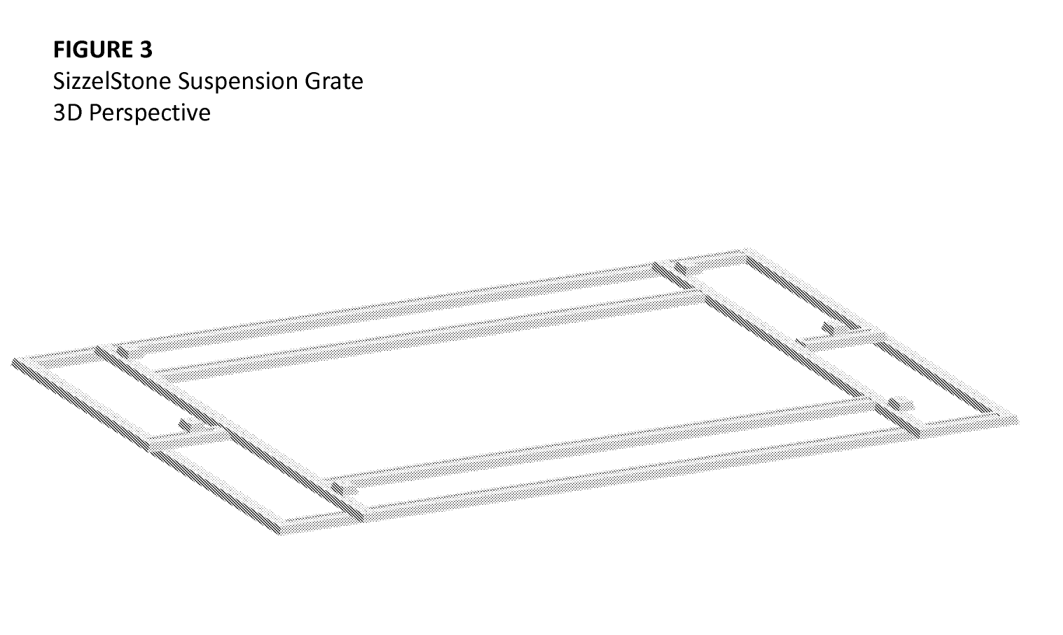

The attached illustration FIG. 3 shows a perspective view of the preferred SizzleStone metamorphic stone suspension grate.

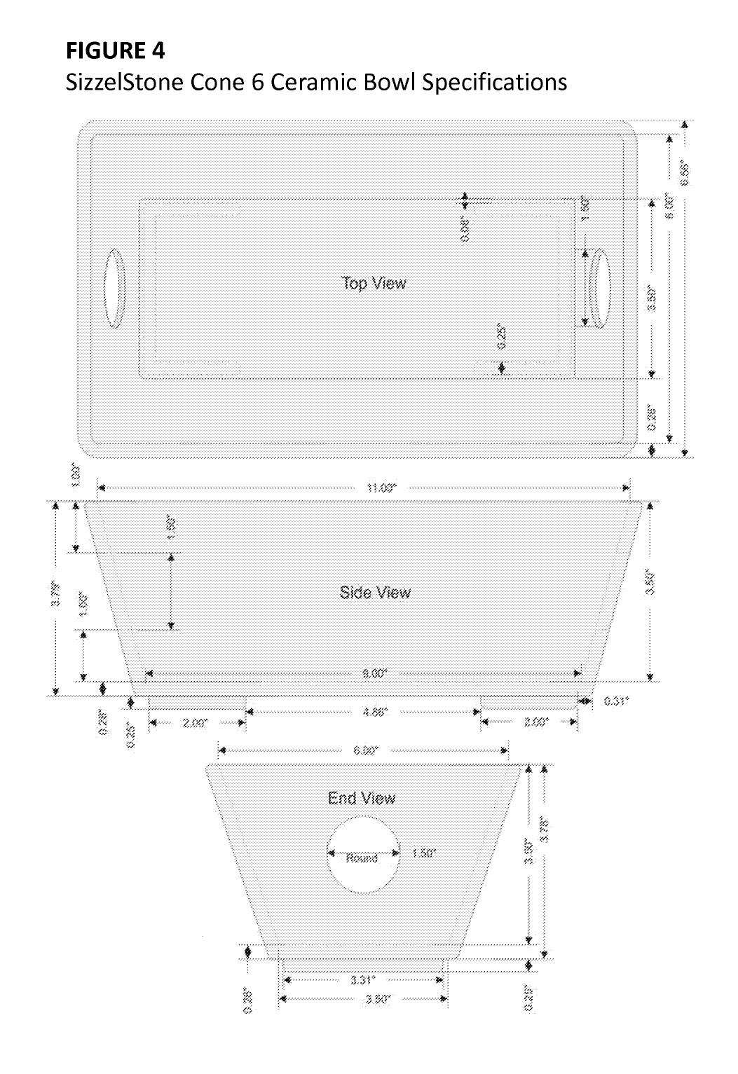

The attached illustration FIG. 4 shows the preferred SizzleStone metamorphic stone Cone 6 Ceramic Bowl, with preferred specifications.

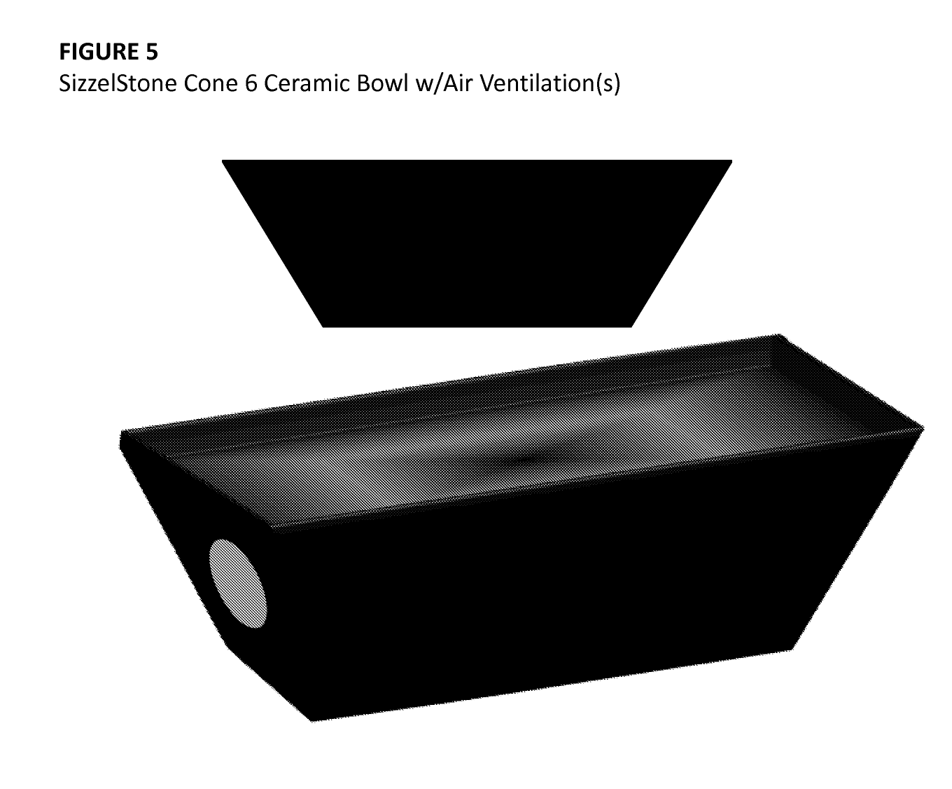

The attached illustration FIG. 5 shows a perspective view of the preferred SizzleStone Cone 6 Ceramic Bowl, with air ventilation holes.

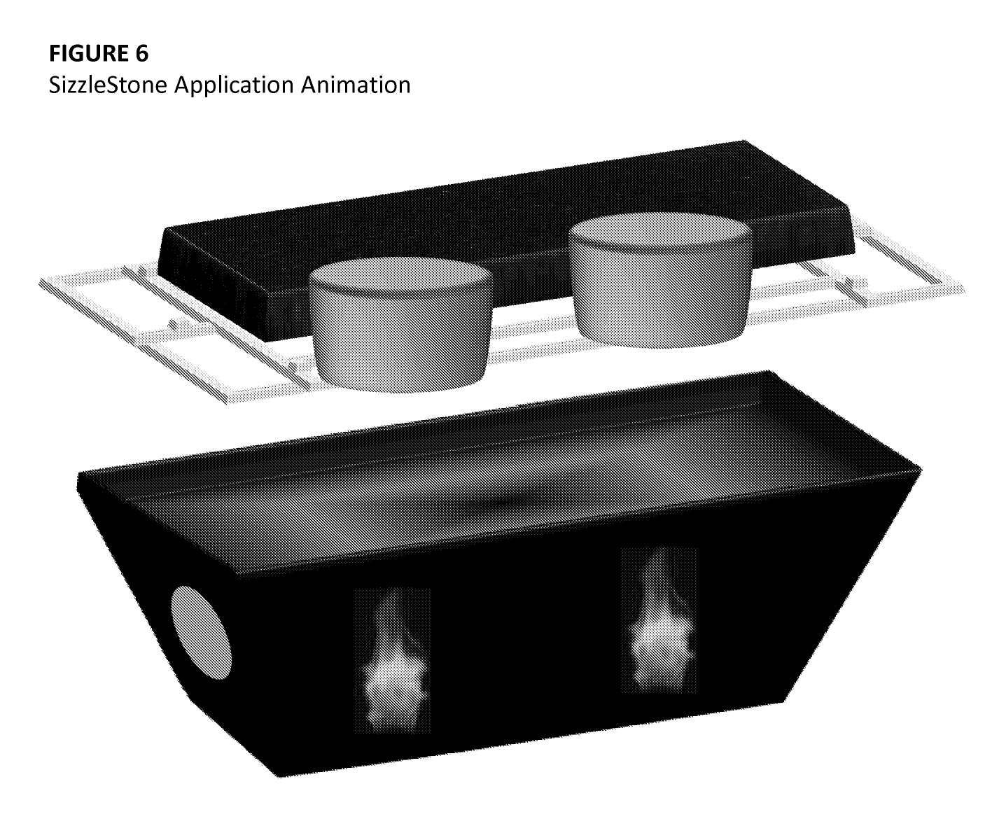

The attached illustration FIG. 6 shows the preferred SizzleStone metamorphic stone apparatus, complete with the suspension grate, ceramic bowl and continuous heating source.

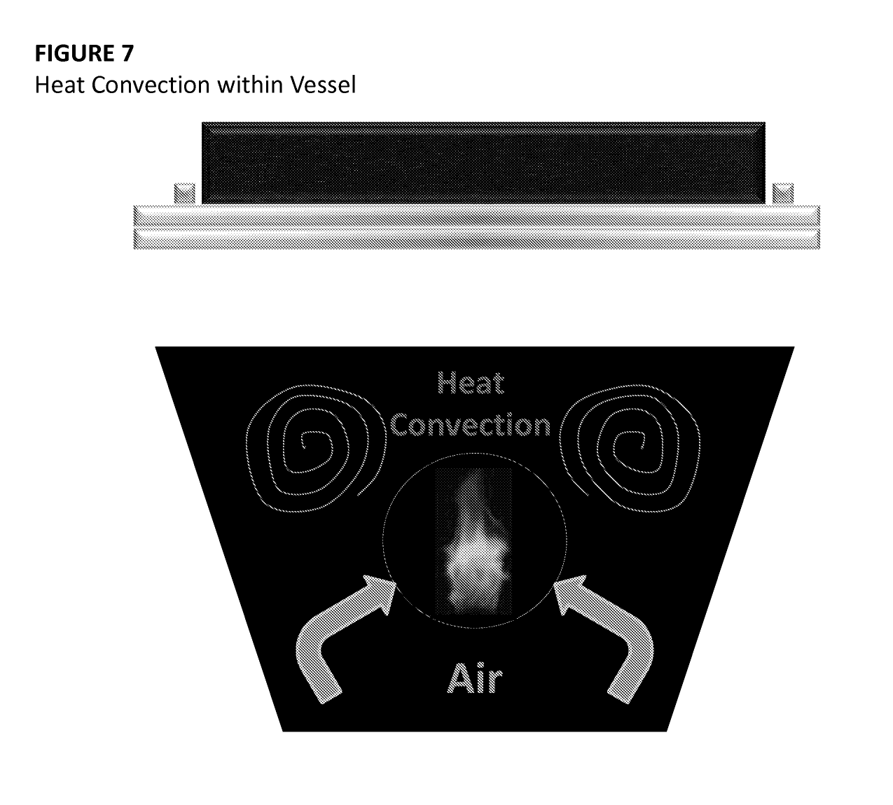

The attached illustration FIG. 7 shows the preferred SizzleStone metamorphic stone apparatus, and particularly the dynamics of the important heat convection process.

What is claimed is:

1. A table-top grill comprising:
a metamorphic cooking stone;
a grate upon which the metamorphic cooking stone is mounted;
a bowl upon which the grate is mounted; and
a source of continuous heat, wherein the bowl is adapted to contain the source of continuous heat in a manner which creates convection heating inside the bowl and under the grate and metamorphic cooking stone.

2. The table-top grill of claim 1, wherein the metamorphic cooking stone is granite.

3. The table-top grill of claim 2, wherein the grate is stainless steel.

4. The table-top grill of claim 2, wherein the source of continuous heat is at least one disposable can containing a mixture of formulated, denatured alcohol, water and gel.
